(19) United States
(12) Patent Application Publication
(10) Pub. No.: US 2008/0299436 A1
(43) Pub. Date: Dec. 4, 2008

(54) COMPOSITE CERAMIC ELECTROLYTE STRUCTURE AND METHOD OF FORMING; AND RELATED ARTICLES

(75) Inventors: Todd-Michael Striker, Guilderland, NY (US); James Anthony Ruud, Delmar, NY (US); Stephane Renou, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/755,044

(22) Filed: May 30, 2007

(51) Int. Cl. H01M 8/10; H01M 6/18

(52) U.S. Cl. 429/33; 429/30; 429/304

(57) ABSTRACT

A composite ceramic electrolyte is provided. The composite ceramic electrolyte has a microstructure, which comprises a first ceramic composition comprising a plurality of nano-dimensional microcracks, and a second ceramic composition substantially embedded within at least a portion of the plurality of nano-dimensional microcracks. The first and the second compositions are different. A solid oxide fuel cell comprising a composite ceramic electrolyte having such a microstructure is provided. A method of making a composite ceramic electrolyte is also described. The method includes the steps of: providing a first ceramic composition comprising a plurality of nano-dimensional microcracks; and closing a number of the nano-dimensional microcracks with a second ceramic composition, wherein the first and the second compositions are different, so as to form a composite ceramic electrolyte having a microstructure which comprises a first ceramic composition comprising a plurality of nano-dimensional microcracks and a second ceramic composition substantially embedded within at least a portion of the plurality of nano-dimensional microcracks.

### BACKGROUND OF THE INVENTION

The invention Is related to a composite ceramic electrolyte. The invention is also related to a method of forming a composite ceramic electrolyte, and devices made therefrom.

Solid oxide fuel cells (SOFCs) are promising devices for producing electrical energy from fuel with high efficiency and low emissions. One barrier to the widespread commercial use of SOFCs is the high manufacturing cost. The manufacturing cost is largely driven by the need for state-of-the-art ceramic anodes, cathodes, or electrolytes, which allow the fuel cells to operate at high temperatures (e.g., about 800° C.). Fuel cell components that can meet these criteria require materials of construction that can be expensive to manufacture. Solid oxide fuel cells need to have high power densities and fuel utilizations, and need to be large in size, in order to make the technology economically feasible.

Thermal spray processes, such as air plasma spray, have the potential to provide large-area cells on interconnect supports that may reduce manufacturing costs. However, air-plasma-sprayed coatings typically contain both pores and microcracks, which in the case of a ceramic electrolyte may provide leak paths for the fuel and air. Microcracks of this type are typically formed at interlamellar splat boundaries during deposition, or are formed through the thickness of the coating, due to large thermal expansion strains caused during deposition. Such defects may limit the open cell voltage and fuel utilization. Therefore, there is a continuous need to improve the performance of a ceramic electrolyte.

### BRIEF DESCRIPTION OF THE INVENTION

The present invention meets these and other needs by providing a composite ceramic electrolyte having substantially reduced permeability.

One embodiment of the invention is a composite ceramic electrolyte. The composite ceramic electrolyte has a microstructure, which comprises a first ceramic composition comprising a plurality of nano-dimensional microcracks; and a second ceramic composition substantially embedded within at least a portion of the plurality of nano-dimensional microcracks. The first and the second compositions are different from each other.

Another embodiment is a solid oxide fuel cell. The solid oxide fuel cell comprises an anode; a cathode; and a composite ceramic electrolyte disposed between the anode and the cathode. The composite ceramic electrolyte has a microstructure, which comprises a first ceramic composition comprising a plurality of nano-dimensional microcracks; and a second ceramic composition substantially embedded within at least a portion of the plurality of nano-dimensional microcracks, wherein the first and the second compositions are different.

In another embodiment, the invention provides a method of forming a composite ceramic electrolyte. The method comprises the steps of providing, a first ceramic composition comprising a plurality of nano-dimensional microcracks; and closing a number of the nano-dimensional microcracks with a second ceramic composition, wherein the first and the second compositions are different; so as to form a composite ceramic electrolyte having a microstructure which comprises a first ceramic composition comprising a plurality of nano-dimensional microcracks and a second ceramic composition substantially embedded within at least a portion of the plurality of nano-dimensional microcracks.

These and other features, aspects, and advantages of the present invention will become better understood when the following detailed description is read with reference to the accompanying drawings in which like characters represent like parts throughout the drawing.

### DESCRIPTION OF THE DRAWINGS

FIG. 1 is a cross sectional scanning electron micrograph of a sample air plasma sprayed yttria-stabilized zirconia ceramic electrolyte having nano-dimensional microcracks and pores;

FIG. 2 is a schematic view of a composite ceramic electrolyte, according to one embodiment of the invention;

FIG. 3 is a schematic view of a solid oxide fuel cell comprising a composite ceramic electrolyte, according to one embodiment of the invention;

FIG. 4 illustrates an enlarged, portion of an exemplary fuel cell assembly, showing the operation of the fuel cell;

FIG. 5 is flow chart of a method, according to one embodiment of the invention, for preparing a composite ceramic electrolyte;

FIG. 6 is flow chart of a method, according to another embodiment of the invention, for preparing a composite ceramic electrolyte;

FIG. 7 is a cross sectional scanning electron micrograph of a sample processed composite (yttria-stabilized zirconia)-(gadolinium doped ceria) ceramic electrolyte; and

FIG. 8 is a plot showing the change in permeability after each coating and heat treatment, for a sample air plasma sprayed yttria-stabilized composite ceramic electrolyte.

### DETAILED DESCRIPTION OF THE INVENTION

In the following description, like reference characters designate like or corresponding parts throughout the several views shown in the figures. It is also understood that terms such as “top,” “bottom,” “outward,” “inward,” “first,” “second,” and the like are words of convenience and are not to be construed as limiting terms. Furthermore, whenever a particular aspect of the invention is said to comprise or consist of at least one of a number of elements of a group and combinations thereof, it is understood that the aspect may comprise or consist of any of the elements of the group, either individually or in combination with any of the other elements of that group.

As used herein, “a nano-dimensional microcrack” is meant to describe a microcrack with at least one of the dimensions (length, width, or breadth) in the nanometer range. As used herein, a microcrack is meant to encompass any kind of crack, crevice, or an opening of any shape. In the following embodiments, nano-dimensional microcracks typically have an average width less than about 200 nanometers, and an average length less than about 2000 nanometers.

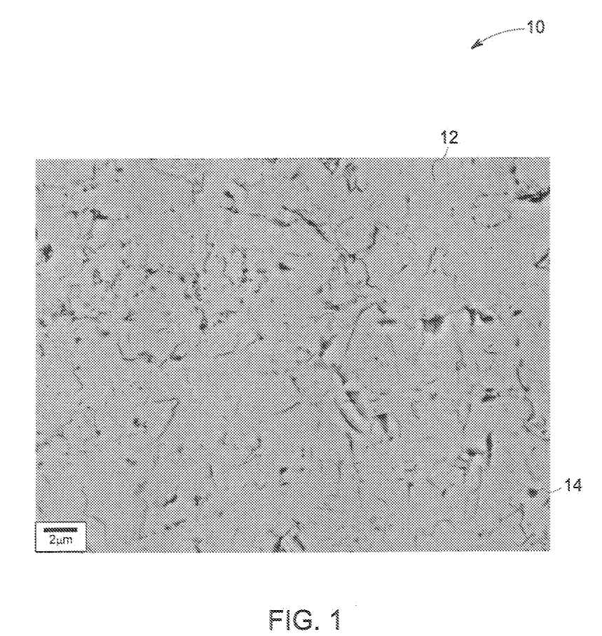

FIG. 1 shows a cross sectional scanning electron micrograph of a sample ceramic electrolyte 10 formed by an air plasma deposition technique. (Other deposition techniques could have been used to deposit the ceramic material, such as vacuum plasma spray (VPS), chemical vapor deposition (CVD), electrodeposition, electron beam plasma vapor deposition (EBPVD), plasma vapor deposition (PVD) etc). The micrograph of the as-deposited layer shows a plurality of defects, such as nano-dimensional microcracks 12 and pores 14 formed during the deposition process. Such defects may impair the hermeticity of the layer. Therefore, it is desirable to develop a ceramic electrolyte that is less permeable, and thus, has a higher open, circuit voltage (OCV) and fuel utilization during operation, as compared with the microcracked structure. The inventors have discovered that providing a composite ceramic electrolyte comprising a second ceramic composition (or second phase) within the nano-dimensional microcracks of a matrix phase (herein referred to us “first ceramic composition”) allows for effective “healing” or “closing” of the nano-dimensional microcracks. This results in the reduction of permeability. The decrease in permeability in this instance is greater than that achieved if the second composition were identical to the first composition. Disclosed herein is also a versatile method to fabricate a composite ceramic electrolyte with the desired microstructure.

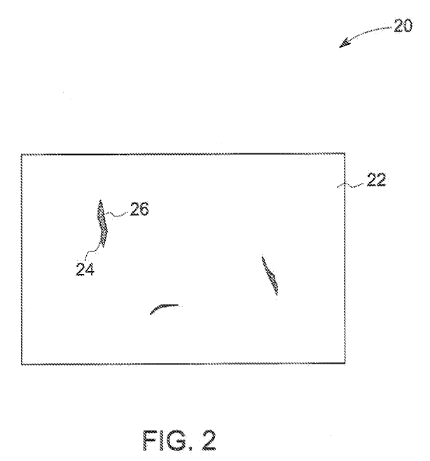

One embodiment of the invention is a composite ceramic electrolyte. FIG. 2 shows a schematic of a sample composite ceramic electrolyte 20. The composite ceramic electrolyte has a microstructure, which comprises a first ceramic composition 22 comprising a plurality of nano-dimensional microcracks 24; and a second ceramic composition 26 substantially embedded within at least a portion of the plurality of nano-dimensional microcracks. In this figure, the nano-dimensional microcrack 24 is completely filled with the second ceramic composition 26, but it should be understood that the microcrack need only be partially filled, as described in detail below. Typically, the first and the second compositions are different from each other.

In these embodiments, the composite ceramic electrolyte is in the form of a monolithic structure. A “monolithic structure” as used herein, means a three-dimensional body portion constituting a single unit without a joint. This is in contrast to a body formed of multiple components, such as a laminated structure, or a multi-layered structure. The monolithic structure that does not have an inherent interface is expected to be substantially free of delamination problems. Delamination may lower the electrolyte ionic conductivity,

The microstructure of the as-deposited first ceramic composition, including dimensions of the microcracks and porosity of the electrolyte, depends mainly on the deposition technique and processing conditions. In one embodiment, the nano-dimensional microcracks have an average microcrack width of less than about 200 nanometers. In another embodiment, the nano-dimensional microcracks have an average microcrack length of less than about 2000 nanometers. (Both dimensional attributes can be present in a single microstructure as well). The microcrack dimensions may he tuned by adjusting the processing parameters, as known in the art. Typically, the plurality of nano-dimensional microcracks has, on average, an aspect ratio of at least about 4. In a specific embodiment, the plurality of nano-dimensional microcracks has, on average, an aspect ratio in the range from about 8 to about 12. Typically, the as-deposited first ceramic composition layer has a porosity of more than about 5 volume percent. The composite electrolyte typically has a porosity less than the as-deposited first ceramic composition layer. In one embodiment, the composite electrolyte has a porosity of less than about 5 volume percent. In another embodiment, the porosity is less, than about 2 volume percent.

The composition of the composite ceramic electrolyte, in part, depends on the end-use application. When the composite ceramic electrolyte is used in a solid oxide fuel cell, or an oxygen- or synthesis gas generator, the electrolyte may be composed of a material capable of conducting ionic species (such as oxygen ions or hydrogen ions), yet may have low electronic conductivity. When the composite ceramic, electrolyte, is used in a gas separation device, the composite ceramic electrolyte may be composed of a mixed ionic electronic conducting material. In all the above embodiments, the electrolyte may be desirably gas-tight to electrochemical reactants.

With reference to FIG. 2, the first ceramic composition 22 typically comprises an ionic conductor. In general, for solid oxide fuel cell applications, the composite ceramic electrolyte has an ionic conductivity of at least about 10⁻³S/cm at the operating temperature of the device, and also has sufficiently low electronic conductivity. Examples of suitable materials for the first ceramic composition 22 include, but are not limited to, various forms of zirconia, ceria, hafnia, bismuth oxide, lanthanum gallate, thoria, and various combinations of these ceramics. In certain embodiments, the first ceramic composition 22 comprises a material selected from the group consisting of yttria-stabilized zirconia, rare-earth-oxide-stabilized zirconia, scandia-stabilized zirconia, rare-earth doped ceria, alkaline-earth doped ceria, rare-earth oxide stabilized bismuth oxide, and various combinations of these compounds. In an exemplary embodiment, the first ceramic composition 22 comprises yttria-stabilized zirconia. Doped zirconia is attractive as it exhibits substantially pure ionic conductivity over a wide range of oxygen partial pressure levels. In one embodiment, the first ceramic composition 22 comprises a thermally sprayed yttria-stabilized zirconia. One skilled in the art would know how to choose an appropriate first ceramic composition 22, based on the requirements discussed herein.

In the case of an electrolytic oxygen separation device, oxygen is driven across the membrane by applying a potential, difference and supplying energy. In such embodiments, the first ceramic composition 22 is usually chosen from electrolytes well known in the art, such as yttria-stabilized zirconia (e.g., (ZrO₂)_{0.92}(Y₂O₃)_{0.08}, YSZ), scandia-stabilized zirconia (SSZ), doped ceria such as (CeO₂)_{0.8}(Gd₂O₃)_{0.2} (CGO), doped lanthanum gallate such as La_{0.8}Sr_{0.2}Ga_{0.85}Mg_{0.15}O_{2.285} (LSGM), and doped bismuth oxide such as (Bi₂O₃)_{0.75}(Y₂O₃)_{0.25}, and the like.

In the case of a gas separation device, where partial pressures, rather than applied potential, are used to move ions across the electrolyte, the first ceramic composition 22 is often a mixed ionic electronic conductor (MIEC). Non-Limiting examples of mixed ionic electronic conductor are La₁₋ₓSrₓCoO₃₋₈; (2≧×≧0.10)(LSC), SrCo₁₋ₓFeₓO₃₋₅;(0.3≧×≧0.20), La_{0.6}Sr_{0.4}Co_{0.6}Fe_{0.4}O_{3.8}; LaNi_{0.6}Fe_{0.4}O₃, and Sm_{0.5}Sr_{0.5}CoO₃.

Typically, the second ceramic composition 26 comprises an oxide. In some embodiments, the oxide is selected from the group consisting of a rare-earth oxide, a transition metal oxide, and an alkaline earth metal oxide, in certain particular embodiments, the oxide Is selected from the group consisting of alumina, bismuth oxide, ceria, lanthanum gallate, silica, hafnia, thoria, zirconia, yttria, calcium oxide, gadolinium oxide, samarium oxide, and europium oxide. In an exemplary embodiment, the second ceramic composition 26 comprises gadolinium-doped ceria.

According to the embodiments of the invention, it was discovered that the permeability of the ceramic electrolyte is significantly reduced when the second ceramic composition 26 is incorporated into the nano-dimensional microcracks 24. Permeability of the composite electrolyte 20 may be in part controlled by the extent of the microcrack filling. Accordingly, in certain embodiments, at least one of nano-dimensional microcracks is at least partially embedded with a second ceramic composition 26. In certain specific embodiments, at least some of the nano-dimensional microcracks may be embedded with the second ceramic composition 26, and in other embodiments, substantially all of the microcracks are embedded with the second ceramic composition 26. In certain embodiments, at least about 25 volume percent of the nano-dimensional microcracks are embedded with the second ceramic composition 26 (i.e., measured as a percentage of the total volume of all of the cracks). In other situations, at least about 50 volume percent of the nano-dimensional microcracks are embedded. In some instances, about 25 volume percent to about 75 volume percent of the nano-dimensional microcracks are embedded with the second ceramic composition (26).

Typically, the composite ceramic electrolyte 20 comprises less than about 10 volume percent of the second ceramic composition 26, based on the total volume of the composite ceramic electrolyte. The amount of the second ceramic composition 26 present is usually in a range from about 1 volume percent to about 6 volume percent, based on the total volume of the composite ceramic electrolyte 20. Based in part on the teachings herein, one skilled in the art would know how to optimize the composition of the components, and their volume fractions, depending on the device structure and operation conditions.

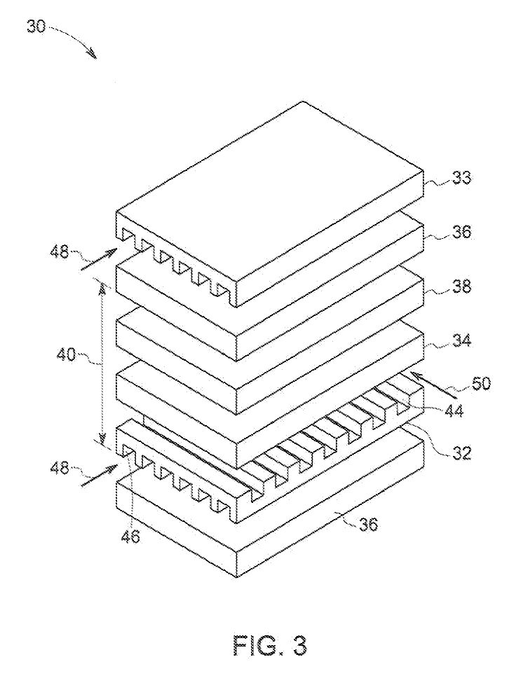

Another embodiment of the invention is a solid, oxide fuel cell (SOFC). A fuel cell is an energy conversion device that produces electricity by electrochemically combining a fuel and an oxidant across an ionic conducting layer. As shown in FIG. 3, an exemplary planar fuel cell 30 comprises interconnect portions 32 and 33, and a pair of electrodes—a cathode 34 and an anode 36, separated by a ceramic electrolyte 38. In general, this cell arrangement is well-known in the art, although the configuration depicted in the figure may be modified, e.g., with the anode layer above the electrolyte, and the cathode layer below the electrolyte. Those skilled in the art understand that fuel cells may operate horizontally, vertically, or in any orientation.

The interconnect portion 32 defines a plurality of airflow channels 44 in intimate contact with the cathode 34, and a plurality of fuel flow channels 46 in intimate contact with the anode 36 of an adjacent cell repeat unit 40, or vice versa. During operation, a fuel flow 48 is supplied to the fuel flow channels 46. An airflow 50, typically heated air, is supplied to the airflow channels 44. Interconnects 32 and 33 may he constructed in a variety of designs, and with a variety of materials. Typically, the interconnect is made of a good electrical conductor such as a metal or a metal alloy. The interconnect desirably provides optimized contact area with the electrodes.

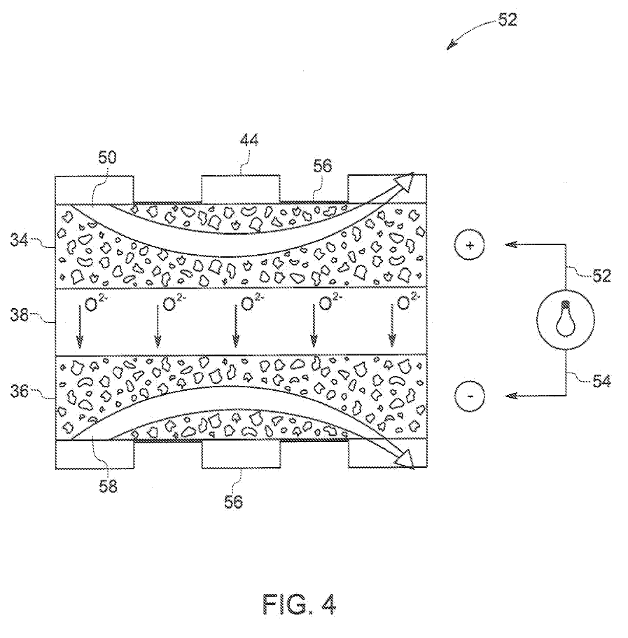

FIG. 4 shows a portion of the fuel cell illustrating its operation. The fuel flow 58 for example, natural gas, is fed to the anode 36, and undergoes an oxidation reaction. The fuel at the anode reacts with oxygen ions (O²⁻) transported to the anode across the electrolyte. The oxygen ions (O²⁻) are de-ionized to release electrons to an external electric circuit 54. The airflow 50 is fed to the cathode 34. As the cathode accepts electrons from the external electric circuit 54, a reduction reaction occurs. The composite electrolyte 38 conducts ions between the anode 36 and the cathode 34. The electron flow produces direct current electricity, and the process produces certain exhaust gases and heat.

In the exemplary embodiment shown in FIG. 3, the fuel cell assembly 30 comprises a plurality of repeating units 40, having a planar configuration. Multiple cells of this type may be provided in a single structure. The structure may be referred to as a “stack”, an “assembly”, or a collection of cells capable of producing a single voltage output,

The main purpose of the anode layer 36 is to provide reaction sites for the electrochemical oxidation of a fuel introduced into the fuel cell. In addition, the anode material is desirably stable in the fuel-reducing environment, and has adequate electronic conductivity, surface area and catalytic activity for the fuel gas reaction under operating conditions. The anode material desirably has sufficient porosity to allow gas transport to the reaction sites. The anode layer 36 may be made of any material having these properties, including but not limited to, noble metals, transition metals, cermets, ceramics and combinations thereof. Non-limiting examples of the anode layer material include nickel, nickel alloy, cobalt, Ni—YSZ cermet, Cu—YSZ cermet, Ni—Ceria cermet, or combinations thereof. In certain embodiments, the anode layer comprises a composite of more than one material.

The cathode layer 34 is typically disposed adjacent to the composite electrolyte 38. The main purpose of the cathode layer 34 is to provide reaction sites for the electrochemical reduction of the oxidant. Accordingly, the cathode layer 34 is desirably stable in the oxidizing environment, has sufficient electronic and ionic conductivity, has a surface area and catalytic activity for the oxidant gas reaction at the fuel cell operating conditions, and has sufficient porosity to allow gas transport to the reaction sites. The cathode layer 34 may be made of any materials meeting these properties, including, but not limited to, an electrically conductive, and in some cases ionically conductive, catalytic oxide such as, strontium doped LaMnO₃, strontium doped PrMnO₃, strontium doped lanthanum ferrites, strontium doped lanthanum cobaltites, strontium doped lanthanum cobaltite ferrites, strontium ferrite, SrFeCo_{0.5}Oₓ, SrCo_{0.8}Fe_{0.2}O₃₋₈; La_{0.8}Sr_{0.2}Co_{0.8}Ni_{0.2}O₃₋₈; and La_{0.7}Sr_{0.3}Fe_{0.8}Ni_{0.2}O₀₋₈, and combinations thereof. A composite of such an electronically conductive, catalytically active material and an ionic conductor may be used. In certain embodiments, the ionic conductor comprises a material selected from the group consisting of yttria-stabilized zirconia, rare-earth-oxide-stabilized zirconia, scandia-stabilized zirconia, rare-earth doped ceria, alkaline-earth doped ceria, rare-earth oxide stabilized bismuth oxide, and various combinations of these compounds.

Typically, the composite electrolyte layer 38 is disposed between the cathode layer 34 and the anode layer 36. The main purpose of the electrolyte layer 38 is to conduct ions between the anode layer 36 and the cathode layer 34. The electrolyte carries ions produced at one electrode to the other electrode to balance the charge from the electron flow, and to complete the electrical circuit in the fuel cell. Additionally,, the electrolyte separates the fuel from the oxidant in the fuel cell. Typically, the composite electrolyte 38 is substantially electrically insulating. Accordingly, the composite electrolyte 38 is desirably stable in both the reducing and oxidizing environments, impermeable to the reacting gases, adequately ionically conductive at the operating conditions, and compliant with the adjacent anode 36 and cathode 34. The composite ceramic electrolyte described, for embodiments of the present invention has substantially high compliance, and superior gas-tight characteristics. These features provide distinct advantages over conventionally deposited ceramic electrolytes.

In some embodiments of the present invention, as discussed above, the composite ceramic electrolyte has a microstructure which comprises a first ceramic composition comprising a plurality of nano-dimensional microcracks and a second ceramic composition substantially embedded within at least a portion of the plurality of nano-dimensional microcracks. The first and the second compositions are different from each other. The composite ceramic electrolyte may have, any suitable first and second ceramic compositions, microcrack dimensions, and thicknesses, including those listed in the embodiments discussed previously. The composite ceramic electrolyte has a gas permeability, measured in air, of less than about 8×10⁻¹¹ cm²Pa⁻¹sec⁻¹.

The anode, cathode, and electrolyte layers are illustrated as single layers for purposes of simplicity of explanation. It should be understood, however, that the anode layer may have a single/multiple layers in which the particle size is graded within the individual layer. The composition of the material may also be graded for thermal compatibility purposes. In another example, the electrolyte structure may be used for a tubular geometry. Furthermore, though the operation of the cell is explained with a simple schematic, embodiments of the present invention are not limited to this particular simple design. Various, other designs—some of them complex—are also applicable, as will be appreciated by those skilled in the art. For example, in certain embodiments, the fuel cell may comprise a composite electrode-electrolyte structure, rather than individual electrode (anode/cathode) and electrolyte layers. Such composite structures may also be incorporated with, electrocatalytic materials such as La₁₋ₓSrₓMnO₃ (LSM), La₁₋ₓSrₓCoO₃ (LSC), La₁₋ₓSrₓFeO₃ (LSF), SrFeCo_{0.5}Oₓ, SrCo_{0.8}Fe_{0.2}O₃₋₈; La_{0.8}Sr_{0.2}Co_{0.8}Ni_{0.2}O₃₋₈; and La_{0.7}Sr_{0.3}Fe_{0.8}Ni_{0.2}O₃₋₈, to enhance their performance. The fuel cell may comprise additional layers, such as buffer layers, support layers, and the like, helping to better match the coefficient of thermal expansion (CTE) of the layers. In addition, barrier layers may be included in the fuel cell to prevent detrimental chemical reactions from, occurring during operation. These layers may be in various forms, and may be prepared by various known techniques. As one example, the buffer/support layers may be a porous foam or tape, or in the form of a knitted wire structure.

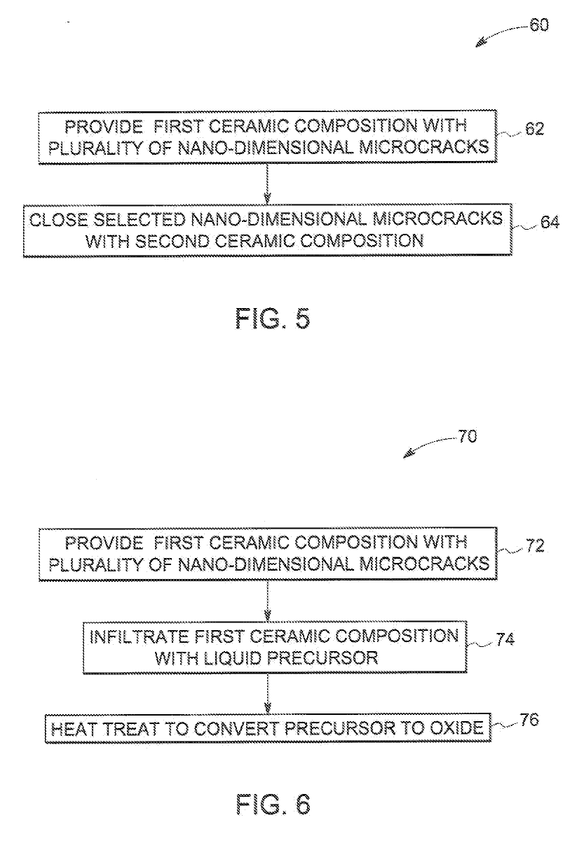

Another embodiment of the invention is a method of making a composite ceramic electrolyte. FIG. 5 shows a flow chart of a process 60 to form a composite ceramic electrolyte. The method comprises the steps of: providing a first ceramic composition comprising a plurality of nano-dimensional microcracks in step 62; and closing a number of the nano-dimensional microcracks with a second ceramic composition in step 64, so as to form a composite ceramic electrolyte having a microstructure which comprises a first ceramic composition comprising a plurality of nano-dimensional microcracks and a second ceramic composition substantially embedded within at least a portion of the plurality of nano-dimensional microcracks. The first and the second compositions are different from each other.

To start with, a first ceramic composition comprising a plurality of nano-dimensional microcracks is provided in step 62. The first ceramic composition layer may be fabricated, by any known process in the art, e.g., by thermal deposition techniques. Examples of suitable thermal deposition techniques include, but are not limited to, plasma spraying, flame spraying, and detonation coating. Such layers typically have nano-dimensional microcracks. Alternatively, the first ceramic composition layer may be deposited from a vapor phase such as plasma vapor deposition (PVD), electron beam plasma vapor deposition (EBPVD), or chemical vapor deposition (CVD). The ceramic layer may also be prepared by band casting or screen-printing a slurry, followed by subsequent sintering. Layers manufactured with such processes often contain capillary spaces, which are formed by pores and open microcrack structures.

In an exemplary embodiment, the first ceramic composition is deposited by an air plasma spray (APS) process. Plasma spray coatings are formed by heating a gas-propelled spray of a powdered metal oxide or a non-oxide material with a plasma spray torch. The spray is heated to a temperature at which the powder particles become molten. The spray of the molten particles is directed against a substrate surface, where they solidify upon impact to create the coating. The conventional as-deposited APS microstructure is typically characterized by a plurality of overlapping splats of material, wherein the inter-splat boundaries may be tightly joined, or may be separated by gaps resulting in some pores and microcracks. The ceramic electrolyte may be applied by an APS process, using equipment and processes known in the art. Those skilled in the art understand that the process parameters may be modified, depending on various factors, such as the composition of the electrolyte material, and the desired microstructure and thickness. Typically, the ceramic electrolyte comprising a plurality of nano-dimensional microcracks has a porosity less than about 10 volume percent. The as-deposited ceramic electrolyte is characterized by a gas permeability, measured in air, of less than about 8×10⁻¹⁰ cm²Pa⁻¹sec⁻¹.

A flow chart for an exemplary process 70 for forming a composite ceramic electrolyte is shown in FIG. 6. The method comprises the steps of providing a first ceramic composition with a plurality of nano-dimensional microcracks in step 72. A selected number of nano-dimensional microcracks may then be closed, by infiltrating the first ceramic composition with a liquid precursor, as shown in step 74. The precursor may comprise at least one oxidizable metal ion. The infiltrated first ceramic composition may then be heated to a temperature sufficient to convert the precursor to an oxide, thereby closing a selected number of nano-dimensional microcracks in step 76.

The first ceramic composition is infiltrated with a liquid precursor comprising at least one oxidizable metal ion. In certain embodiments, the liquid precursor is employed (or “used”) in the form of a solution. The solution may comprise any solvent and a soluble salt material that allows formation of the solution. The metals are present in the form of cations. The corresponding anions are inorganic compounds, for example nitrate NO₃, or organic compounds, for example alcoholates or acetates. If alcoholates are used, then chelate ligands, such as acetyl acetonate, may be advantageously added to decrease the hydrolysis sensitivity of the alcoholates. Examples of suitable solvents are toluene, acetone, ethanol, isopropanol, ethylene glycol, and water. Aqueous and alcohol solutions of nitrates, and organic-metallic soluble materials, such as oxalates, acetates, and citrates, may also be used. The solution desirably has suitable wettability and solubility properties to permit infiltration into the pores and microcracks. Infiltration and heating of the first ceramic composition with the second ceramic composition typically lead to decrease in porosity. In one embodiment, the porosity reduction is from about 8% of the volume to about 5.8% of the volume, an approximate decrease in crack volume of about 25%.

When the electrolyte comprises an oxide of a metal “Me”, where “Me” is Zr, Ce, Y, Al or Ca, the precursor solution may comprise a nitrate Me(NO₃)ₓ, where x=2 for Ca, and x=3 for Zr, Ce, Y, Al, Co, Mn, Mg, Ca, Sr, Y, Zr, Al, Ti. Alternatively (or in addition), the precursor solution may comprise a lanthanide, such as Ce, Eu or Gd. The metal nitrates are generally available as crystalline hydrates, for example Ce(NO₃)_{3.6}H₂O, which are easily soluble in water. Metal nitrates decompose into the corresponding oxides at elevated temperatures, while simultaneously forming gaseous NO₂. The conversion temperature at which oxide formation results is known for many of the nitrates and, accordingly, the processing conditions are chosen.

Typically, the oxidizable metal ion may be thermally converted into a metal oxide. After infiltrating a desired number of microcracks, the solvent is evaporated as the temperature increases under heat input, and the metal changes into the metal oxide at an elevated temperature, thereby closing the infiltrated microcracks. As used herein, “closing a selected number of nano-dimensional microcracks” encompasses reducing the dimension of the nano-dimensional microcracks by filling the nano-dimensional microcracks, or by closing the surfaces of the cracks. In the heat treatment, the heat input can be carried out by various techniques, e.g., in a thermal oven, in a microwave oven, with a heat radiator, or with a flame. A multiple repetition of the infiltration and healing processes may be carried out in order to achieve any specific microstructure and gas permeability values.

The embodiments of the present invention are fundamentally different from those conventionally known in the art. There have been reports of infiltrating highly porous ceramic layers with metal ions, and heat treating them in order to density the ceramic layer. In such cases, the initial ceramic layers are highly porous (porosity>10%) and have micron-sized microcracks that result in relatively higher gas permeability (higher than 3.5×10⁻¹⁰ cm²Pa⁻¹sec⁻¹ measured in air) after infiltrating with metal ions. As a result, such processed products have different characteristics, compared to the composite electrolytes described heroin.

The following examples serve to illustrate the features and advantages offered by the present invention, and are not intended to limit the invention thereto.

Example. Preparation of composite yttria-stabilized zirconia (YSZ)-gadolinium doped ceria (GDC).

Gadolinium and cerium nitrate aqueous precursor solutions were prepared and mixed in the appropriate ratios to yield a 1.2 M solution with a 20 mol % Gd doped CeO₂ (20GDC) final composition, after nitrate decomposition and oxidation. A one inch (2.54 cm) diameter porous stainless steel substrate with a 65 micron thick 8 mol % yttria stabilized zirconia (8YSZ) air plasma sprayed (APS) electrolyte was used as a baseline. The 20GDC nitrate solution was painted at 3.5 mg/cm² onto the APS coating, during which the solution visibly wicked into the permeable coating. The substrate was air dried at room temperature and 70° C. for approximately 5 minutes each. The substrate was then placed in a furnace at 300° C. for 1.5 minutes, and then allowed to cool at room temperature. Once fully cooled, the process of painting 20GDC and heat treating at 300° C. was repeated, until a total of 4 treatments were made. A fifth 20GDC painting was applied, after which the sample was heat treated to 500° C. for 0.5 hrs. The four −300° C. heat treatments and the 500° C. process was iterated twice.

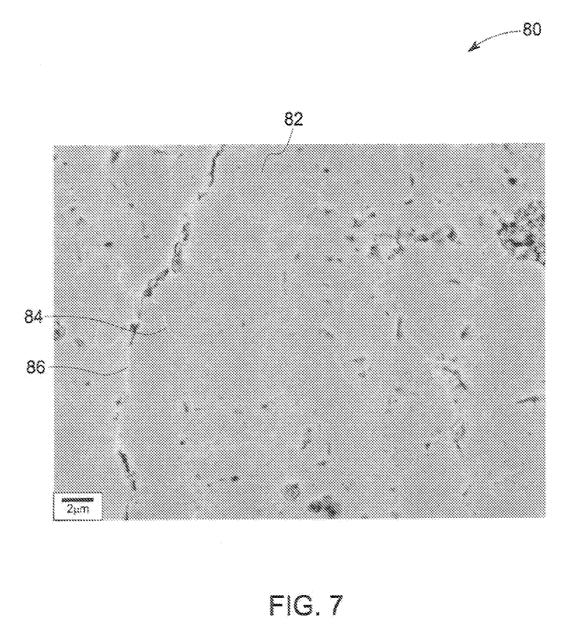

A micrograph of a typical as-deposited APS electrolyte structure is shown in FIG. 1 (discussed previously). The micrograph shows the microcracks and pores throughout the thickness of the coating. FIG. 7. shows the microstructure of a (yttria-stabilized zirconia)-(gadolinium doped ceria) composite ceramic electrolyte 80 after ten nitrate coatings and beat treatments (a total of two iterations of the total 500° C., process). The micrograph shows the second ceramic composition (gadolinium doped ceria) 86 embedded within the microcrack regions 84 of the first ceramic composition (yttria-stabilized zirconia) 82.

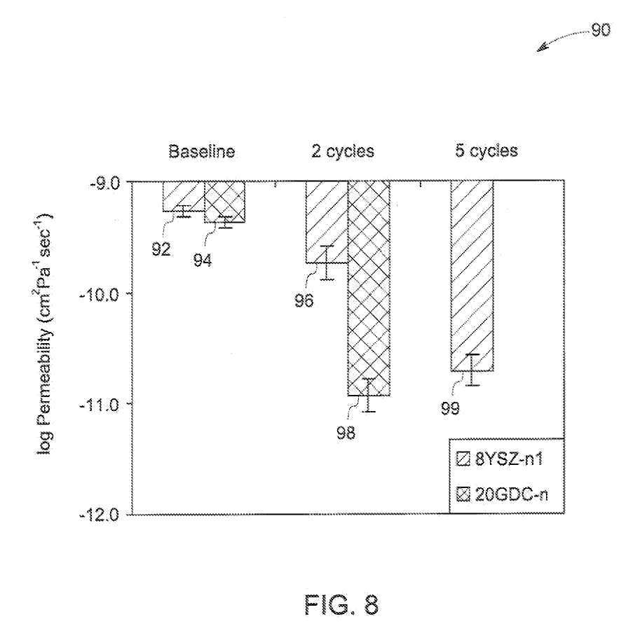

FIG. 8 shows the change in permeability after the two iterations of the total process (plot 90). Bar 92 shows the permeability data for a base substrate and 94 for non-treated first ceramic composition. Bars 96, 98, and 99 show progressive improvement in permeability with infiltration and heat treatment iterations. The process using a different, (secondary) phase (20GDC) has a one-order-of-magnitude advantage in reducing permeability over using the first ceramic composition as a filler (8YSZ). After two iterations using 20GDC as the secondary phase, the permeability was decreased by almost 1.5 orders of magnitude (5×10⁻¹⁰ to 1.2×10⁻¹¹ cm² Pa⁻¹ sec⁻¹) when compared to just the first ceramic composition filling.

While the invention has been described with reference to exemplary embodiments, it will be understood by those skilled in the art that various changes may be made, and equivalents may be substituted for elements thereof, without departing from the scope of the invention. In addition, many modifications may be made to adapt a particular situation or material to the teachings of the invention, without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A composite ceramic electrolyte having a microstructure, which comprises a first ceramic composition comprising a plurality of nano-dimensional microcracks and a second ceramic composition substantially embedded within at least a portion of the plurality of nano-dimensional microcracks, wherein the first and the second compositions are different from each other.

2. The composite ceramic electrolyte of claim 1, wherein the first ceramic composition comprises an ionic conductor.

3. The composite ceramic electrolyte of claim 2, wherein the first ceramic composition comprises a material selected from the group consisting of zirconia, ceria, hafnia, bismuth oxide, lanthanum gallate, and thoria.

4. The composite ceramic electrolyte of claim 3, wherein the first ceramic composition comprises a material selected from the group consisting of yttria-stabilized zirconia, rare-earth-oxide-stabilized zirconia, scandia-stabilized zirconia, rare-earth doped ceria, alkaline-earth doped ceria, stabilized hafnia, rare-earth oxide stabilized bismuth oxide, and lanthanum strontium magnesium gallate.

5. The composite ceramic electrolyte of claim 3, wherein the first ceramic composition comprises yttria-stabilized zirconia.

6. The composite ceramic electrolyte of claim 1, wherein the first ceramic composition comprises a thermally-sprayed yttria-stabilized zirconia.

7. The composite ceramic electrolyte of claim 1, wherein the second ceramic composition comprises an oxide.

8. The composite ceramic electrolyte of claim 7, wherein the oxide is selected from the group consisting of a rare-earth oxide, a transition metal oxide, and an alkaline earth metal oxide.

9. The composite ceramic electrolyte of claim 7, wherein the oxide is selected from the group consisting of alumina, bismuth oxide, ceria, lanthanum, gallate, hafnia, thoria, zirconia, yttria, calcium oxide, gadolinium oxide, samarium oxide, and europium oxide.

10. The composite ceramic electrolyte of claim 9, wherein the second ceramic composition comprises gadolinium-doped ceria.

11. The composite ceramic electrolyte of claim 1, wherein the ceramic electrolyte comprises less than, about 10 volume percent of the second ceramic composition, based on total volume of the composite ceramic electrolyte.

12. The composite ceramic electrolyte of claim 11, wherein the amount of the second ceramic composition present is in a range from about 1 volume percent to about 6 volume percent, based on total volume of the composite ceramic electrolyte.

13. The composite ceramic electrolyte of claim 1, wherein from about 25 volume percent to about 75 volume percent of the plurality of nano-dimensional microcracks are embedded with the second ceramic composition.

14. The composite ceramic electrolyte of claim 13, wherein at least about 50 volume percent of the plurality of nano-dimensional microcracks are embedded with the second ceramic composition.

15. The composite ceramic electrolyte of claim 1, having a gas permeability, measured in air, of less than about 8×10⁻¹¹ cm²Pa⁻¹sec⁻¹.

16. The composite ceramic electrolyte of claim 1, having a porosity of less than about 5 volume percent.

17. The composite ceramic electrolyte of claim 1, wherein the microcracks have an average microcrack length of less than about 2000 nanometers.

18. The composite ceramic electrolyte of claim 1, wherein the microcracks have an average microcrack width of less than about 200 nanometers,

19. The composite ceramic electrolyte of claim 1, wherein the plurality of nano-dimensional microcracks have, on average, an aspect ratio of at least about 4.

20. The composite ceramic electrolyte of claim 1, wherein the plurality of nano-dimensional microcracks have, on average, an aspect ratio in the range from about 8 to about 12.

21. A solid oxide fuel cell comprising the composite ceramic electrolyte of claim 1.

22. A solid oxide fuel cell comprising;
an anode,
a cathode,
and a composite ceramic electrolyte disposed between the anode and the cathode, wherein the composite ceramic electrolyte has a microstructure which comprises a first ceramic composition comprising a plurality of nano-dimensional microcracks and a second ceramic composition substantially embedded within at least a portion of the plurality of nano-dimensional microcracks, wherein the first and the second compositions are different from each other.

23. The solid oxide fuel cell of claim 22, wherein the first ceramic composition comprises a material selected from the group consisting of yttria-stabilized zirconia, rare-earth-oxide-stabilized zirconia, scandia-stabilized zirconia, rare-earth doped ceria, alkaline-earth doped ceria, stabilized hafnia, rare-earth oxide stabilized bismuth oxide, and lanthanum strontium magnesium gallate.

24. The solid oxide fuel cell of claim 23, wherein the first ceramic composition comprises yttria-stabilized zirconia.

25. The solid oxide fuel cell of claim 22, wherein the second ceramic composition comprises an oxide selected from the group consisting of a rare-earth oxide, a transition metal oxide, and an alkaline earth metal oxide.

26. The solid oxide fuel cell of claim 25, wherein the second ceramic composition comprises a gadolinium-doped ceria.

27. The solid oxide fuel cell of claim 22, wherein the ceramic electrolyte comprises less than about 10 volume percent of the second ceramic composition, based on the total volume of the electrolyte.

28. The solid oxide fuel cell, of claim 22, wherein the composite ceramic electrolyte has a gas permeability, measured in air, of less than about 8×10⁻¹¹ cm²Pa⁻¹sec⁻¹.

29. The solid oxide fuel cell of claim 22, wherein the composite ceramic electrolyte has a porosity of less than about 5 volume percent.

30. The solid oxide fuel cell of claim 22, wherein the plurality of nano-dimensional microcracks have an average aspect ratio of at least about 4.

31. A method of forming a composite ceramic electrolyte, comprising;
providing a first ceramic composition comprising a plurality of nano-dimensional microcracks; and
closing a number of the nano-dimensional microcracks with a second ceramic composition, wherein the first and the second compositions are different, so as to form a composite ceramic electrolyte having a microstructure which comprises a first ceramic composition comprising a plurality of nano-dimensional microcracks and a second ceramic composition substantially embedded within at least a portion of the plurality of nano-dimensional microcracks.

32. The method of claim 31, wherein providing the first ceramic electrolyte comprises thermally spraying the first ceramic composition.

33. The method of claim 31, wherein closing the plurality of nano-dimensional microcracks comprises:
infiltrating the ceramic electrolyte with a liquid precursor comprising a plurality of cations, wherein the liquid precursor comprises at least one oxidizable metal ion; and
heating the composite ceramic electrolyte to a temperature sufficient to convert the metal ion to an oxide, thereby closing a selected number of the nano-dimensional microcracks.

34. The method of claim 31, wherein the first ceramic composition comprises yttria-stabilized zirconia.

35. The method of claim 31, wherein the second ceramic composition comprises gadolinium doped ceria.

36. A method of forming a composite ceramic electrolyte, comprising:
providing a first ceramic composition comprising yttria-stabilized zirconia, which itself comprises a plurality of nano-dimensional microcracks, and which has a gas permeability, measured in air, of less than about 8×10⁻¹⁰ cm²Pa⁻¹sec⁻¹;
infiltrating the first ceramic composition with a liquid precursor comprising a plurality of cations, wherein the liquid precursor comprises at least one oxidizable metal ion to form an infiltrated first ceramic composition; and
heating the infiltrated first ceramic composition to a temperature sufficient to convert the metal ion to an oxide, thereby closing a selected number of the nano-dimensional microcracks, resulting in a gas permeability, measure in air, of less than about 8×10⁻¹¹ cm²Pa⁻¹sec⁻¹.
